(19) United States
(12) Patent Application Publication
(10) Pub. No.: US 2026/0127971 A1
(43) Pub. Date: May 7, 2026

(54) PERFORMANCE ANALYTICS ENGINE FOR GROUP RESPONSES

(71) Applicant: Pearson Education, Inc., Bloomington, MN (US)

(72) Inventors: Stephen CARROLL, San Anselmo, CA (US); Brian DAILEY, Aurora, CO (US); Emilia PANKOWSKA, Poznan (PL); Jennifer Arlene COLEMAN, Belmont, MA (US); Zachary ELEWITZ, Minneapolis, MN (US)

(21) Appl. No.: 19/356,689

(22) Filed: Oct. 13, 2025

Related U.S. Application Data
(63) Continuation of application No. 17/130,924, filed on Dec. 22, 2020, now abandoned.

(51) Int. Cl. G09B 7/00; G06F 16/903; G06Q 10/10; G06Q 50/20; H04L 9/40

(52) U.S. Cl. CPC G09B 7/00; G06F 16/90335; G06Q 10/10; G06Q 50/205; H04L 63/10

(57) ABSTRACT

A system including a computer server implementing a learning resource configured to monitor a user interaction with the learning resource, and encode, based on the user interactions, a user event. The system includes a computer server implementing an event processor. The event processor is configured to receive, from the computer server, the user event, parse the user event to determine the identifications of the user generating the user event, the assessment item, and the learning resource, and the indication of whether the user event is associated with a correct answer or an incorrect answer, and store, in an analytics storage database, a data record including the identification of the user generating the user event, the assessment item, the learning resource, and the indication of whether the user event is associated with a correct answer or an incorrect answer.

### RELATED APPLICATIONS

This application is a continuation application of U.S. application Ser. No. 17/130,924, filed Dec. 22, 2020, the entire content of which is incorporated herein by reference.

### FIELD OF THE INVENTION

This disclosure relates to the field of systems and methods configured to process user interaction events across a platform of systems and learning resources to generate performance metrics for items responses generated by a groups of users.

### SUMMARY OF THE INVENTION

The present invention provides systems and methods comprising one or more server hardware computing devices or client hardware computing devices, communicatively coupled to a network, and each comprising at least one processor executing specific computer-executable instructions within a memory.

An embodiment of the present invention includes a system including an analytics storage database and a plurality of computer servers. Each computer server of the plurality of computer servers implements a learning resource. Each learning resource is configured to monitor user interactions with the learning resource, and encode, based on the user interactions, user events, each user event including identifications of the user generating the user event, an assessment item, and the learning resource and including an indication of whether the user event is associated with a correct answer or an incorrect answer. The system includes a computer server implementing an event processor. The event processor is configured to receive, from the plurality of computer servers, a plurality of user events, and, for each user event parse each received user event to determine the identifications of the user generating the user event, the assessment item, and the learning resource, and the indication of whether the user event is associated with a correct answer or an incorrect answer. The events processor is configured to store, in the analytics storage database, a data record including the identification of the user generating the user event, the assessment item, the learning resource, and the indication of whether the user event is associated with a correct answer or an incorrect answer, receive, from a first learning resource, a request to generate an analytics report, determine, from the request, a first assessment item, retrieve, from the analytics storage database, a first set of data records associated with the first assessment item, determine a percentage of data records in the first set of data records associated with a correct answer, determine that the percentage of data records falls below a threshold percentage, and transmit to the first learning resource a report indicating that the first assessment item is associated with a challenging content.

Another embodiment includes a system including a computer server implementing a learning resource configured to monitor a user interaction with the learning resource, and encode, based on the user interactions, a user event including identifications of the user generating the user event, an assessment item, and the learning resource and including an indication of whether the user event is associated with a correct answer or an incorrect answer. The system includes a computer server implementing an event processor. The event processor is configured to receive, from the computer server, the user event, parse the user event to determine the identifications of the user generating the user event, the assessment item, and the learning resource, and the indication of whether the user event is associated with a correct answer or an incorrect answer, and store, in an analytics storage database, a data record including the identification of the user generating the user event, the assessment item, the learning resource, and the indication of whether the user event is associated with a correct answer or an incorrect answer.

An embodiment includes a method including receiving, from a learning resource, a user event, parsing the user event to determine identifications of the user generating the user event, an assessment item, and a learning resource, and an indication of whether the user event is associated with a correct answer or an incorrect answer, and storing, in an analytics storage database, a data record including the identification of the user generating the user event, the assessment item, the learning resource, and the indication of whether the user event is associated with a correct answer or an incorrect answer.

### BRIEF DESCRIPTION OF THE DRAWINGS

FIG. 1 illustrates a system level block diagram for a non-limiting example of a distributed computing environment that may be used in practicing the invention.

FIG. 2 illustrates a system level block diagram for an illustrative computer system that may be used in practicing the invention.

FIG. 3 illustrates a block diagram depicting functional components of the present system.

FIG. 4 is a flowchart depicting a method for receiving and processing user event reports from a plurality of different learning experiences through a user event data pipeline.

FIG. 5 is a flowchart depicting a method for receiving a request to generate a challenging content report request, processing the request, and delivering a completed report.

FIGS. 6A-6G are screenshots depicting example user interfaces generated in accordance with a completed challenging content report generated in accordance with the method of FIG. 5.

FIG. 7 is a block diagram illustrating data flows through the present system.

### DETAILED DESCRIPTION

The present invention will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

In an embodiment, the present system and method is configured to assist instructors, learners, operators, and administrators to identify academic problem areas across educational experiences in a number of different platforms. Education participants may not have the time to analyze analytics about themselves or their content in order to arrive at a decision of what is the next best learning activity they can do in order to advance their academic goals. This may result in knowledge gaps where students or learners are struggling with content but teachers and learning platforms are unaware that students are finding particular content or assessments challenging and so may not provide adequate remediation.

Many of the current approaches to solving this problem entail showing all of the content (chapters, sections, modules, assessments, etc.) with various learning analytics associated with each object and then requiring the learner or instructor to interact with the learning analytics in the context of their content in order to analyze and decide where they should spend their time.

In the present system, as users (also referred to herein as learners) interact with items in assessments across collections of educational experiences their interactions—to the extent the interactions embody answers to assessment questions-include details (e.g., specific item selections and data entries) and an identification of the correctness on the given item (i.e., whether answer was a “correct answer” or an “incorrect answer”) are provided as events to a near real time event data stream. The data stream is communicated to a challenging content data processing system that captures and interrogates those activity events and calculates an average ‘correct on first try’ percent per item and an average ‘correct on first try’ per assessment using the item correct first try statistics. In this manner all items and assessments are given scores which can then be used to rank items and/or assessments when presenting to consumers.

The present system may be implemented in an environment in which multiple different educational resources provide different learning experiences. Such different learning resources may implement evaluations differently within varied educational content hierarchies. In such a diverse resource environment, conventional solutions would require each learning resource to implement its own unique systems and algorithms for surfacing content that may present particular difficulties for users. Using the present system, however, the multiple, different learning resources, are only required to transmit user events to the data stream for processing. The events are then analyzed by the challenging content data processing system, which generates identifications of potentially challenging assessment items or concepts that are then communicated back to the various learning resources in a manner that enables the resources to take appropriate action with the data received from the challenging content data processing system.

In this manner, the present challenging content data processing system operates as a centralized “clearinghouse” for all user events generated by users in a number of disparate learning resources. The challenging content data processing system is configured to process the events to generate unique challenging data reports that are consumable by each of the various learning resources.

Specifically, the present system is enabled through separation of a micro-services layer within the challenging content data processing system that provides the raw calculations and ranking of all content from the analytics experience aggregation layer which provides the filtering of content to a specific experience's content ranking requirements such as: aggregation level (chapter, section, module, assessment), cohort or individual learner's aggregation context (learner challenging items, and threshold setting to return only items above a given rank score for the given experience. The unique analytics experience aggregation layer is therefore configured to generate outputs usable by the various resources or product models interacting with the challenging content data processing system.

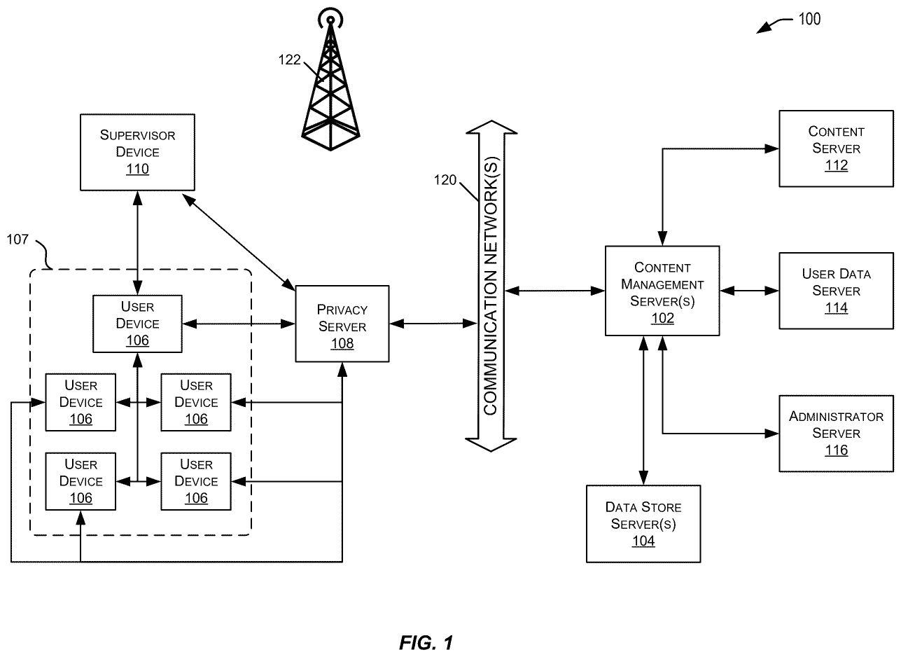

FIG. 1 illustrates a non-limiting example distributed computing environment 100, which includes one or more computer server computing devices 102, one or more client computing devices 106, and other components that may implement certain embodiments and features described herein. Other devices, such as specialized sensor devices, etc., may interact with client 106 and/or server 102. The server 102, client 106, or any other devices may be configured to implement a client-server model or any other distributed computing architecture.

Server 102, client 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

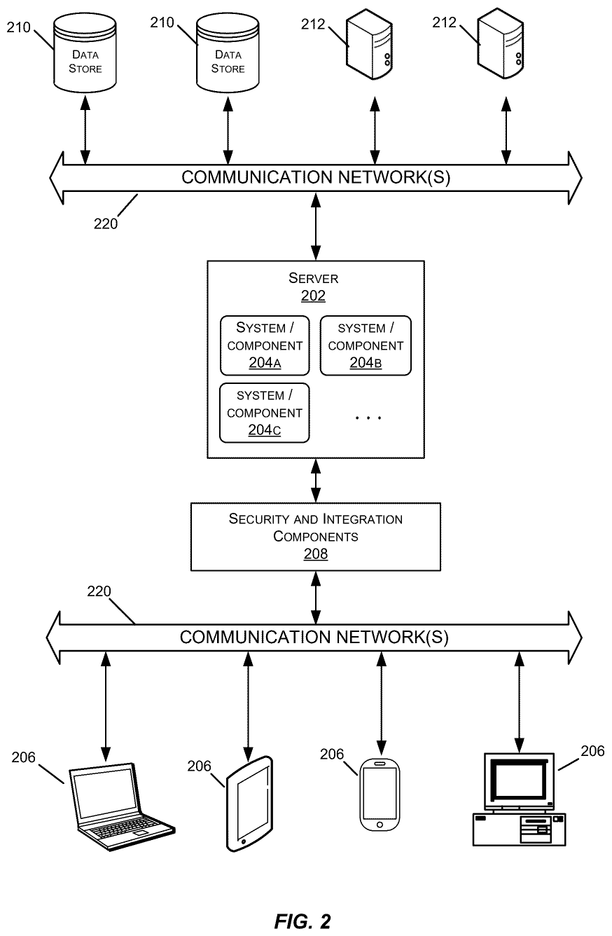

The embodiments shown in FIGS. 1-2 are thus one example of a distributed computing system and is not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems 100 and content distribution networks. Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser based applications and/or standalone software applications, such as mobile device applications. Client devices 106 may receive client applications from server 102 or from other application providers (e.g., public or private application stores).

As shown in FIG. 1, various security and integration components 108 may be used to manage communications over network 120 (e.g., a file-based integration scheme or a service-based integration scheme). Security and integration components 108 may implement various security features for data transmission and storage, such as authenticating users or restricting access to unknown or unauthorized users,

As non-limiting examples, these security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure.

In various implementations, security and integration components 108 may transmit data between the various devices in the content distribution network 100. Security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.).

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML encryption), etc. In other examples, the security and integration components 108 may include specialized hardware, network appliances, and the like (e.g., hardware-accelerated SSL and HTTPS), possibly installed and configured between servers 102 and other network components, for providing secure web services, thereby allowing any external devices to communicate directly with the specialized hardware, network appliances, etc.

Computing environment 100 also may include one or more data stores 110, possibly including and/or residing on one or more back-end servers 112, operating in one or more data centers in one or more physical locations, and communicating with one or more other devices within one or more networks 120. In some cases, one or more data stores 110 may reside on a non-transitory storage medium within the server 102. In certain embodiments, data stores 110 and back-end servers 112 may reside in a storage-area network (SAN). Access to the data stores may be limited or denied based on the processes, user credentials, and/or devices attempting to interact with the data store.

With reference now to FIG. 2, a block diagram of an illustrative computer system is shown. The system 200 may correspond to any of the computing devices or servers of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code, and may maintain multiple concurrently executing programs or processes. Processor(s) 204 may also include one or more specialized processors, (e.g., digital signal processors (DSPs), outboard, graphics application-specific, and/or other processors).

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc.

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include indicator lights, monitors, printers, speakers, headphones, automotive navigation systems, plotters, voice output devices, modems, etc.

Computer system 200 may comprise one or more storage subsystems 210, comprising hardware and software components used for storing data and program instructions, such as system memory 218 and computer-readable storage media 216.

System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc.

System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204.

System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214.

Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage subsystem 210.

Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200.

The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

Due to the ever-changing nature of computers and networks, the description of computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

As disclosed in more detail below, the present system may process a data stream encoding descriptions of user events occurring within various learning resource systems (e.g., software applications configured to deliver content and learning assessments to a number of users and receive responses thereto). As described herein, these events are processed by a processing system to generate analytics data for user assessments across a number of different learning resources. In embodiments, these user actions are processed in real-time or near real-time.

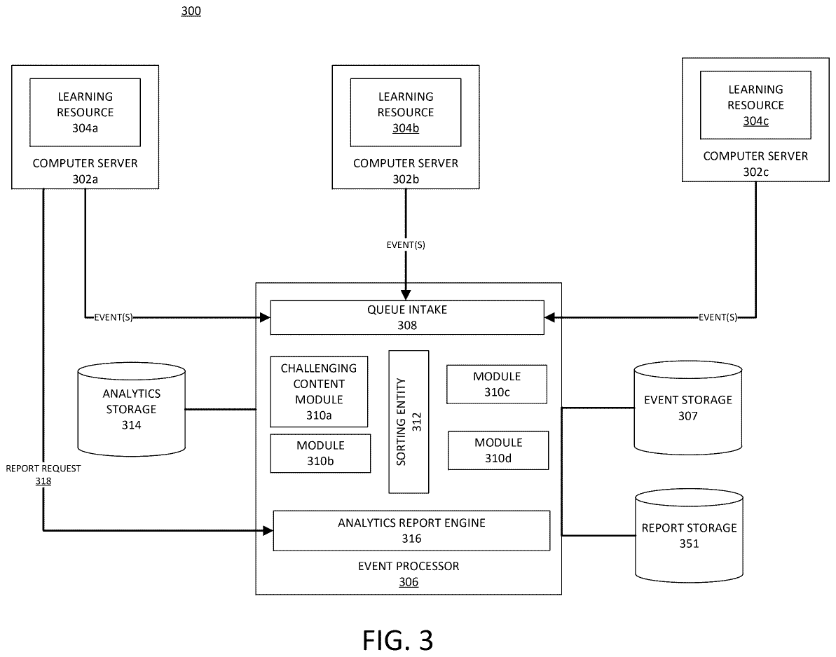

FIG. 3 is a block diagram depicting functional components of the present system. Within environment 300, a number of different computer server systems 302a-304c are configured to implement a number of different learning resources 304a-304c. Although depicted as a single learning resource 304 being implement on a single computer server 302, it should be understood that multiple learning resources 304 may be implemented simultaneously on the same computer server 302 or, alternatively, a single learning resource 304 could be implement across a number of different computer servers 302 in a distributed computing implementation.

Learning resources 304 are typically software applications or learning activities configured to interact with users (learners) to both provide educational content to the users and also deliver assessments to the users. The educational content may be in any suitable form such as written text, multimedia, simulations, and the like. Assessments are generally delivered to users by learning resources 304 in the form of a prompt (e.g., a written question or multimedia depicting a prompt) to which the user provides an input that is received as a response.

When using a learning resource 304, users typically connect to computer servers 302 using a user device (e.g., a laptop computer, desktop computer, tablet, mobile device, or the like) via a suitable network connection. Learning resources 304 deliver educational content and assessments to the user's device through the network connection.

As the user navigates through the various content and prompts delivered by a learning resource 304 (e.g., typically through a software application running on the user's device such as a web browser), the user executes particular actions with the learning resource 304 to interact with the provided content and assessments. The interactions may involve the user executing particular actions within the learning resource 304 thereby causing user events. Actions may involve the user, first, logging into a particular learning resource 304 to gain access to the resource. Other actions may include the user requesting to view particular learning content (e.g., by clicking on a request content link displayed on the user's device), scrolling through learning content, playing or pausing a multimedia content delivered by the learning resource 304, and the like. Events, which include all actions, could also include the user being idle for a particular amount of time within a user resource, or viewing a particular portion of a multimedia content or assessment. Assessment responses may also be user events. When a user logs out of a learning resource 304, that may still further be recorded as an event within the learning resource 304.

The various events a user may trigger within a learning resource 304 (e.g. by undertaking particular actions within the learning resource) may provide information regarding how users are interacting with learning content and assessments. Such information can be analyzed, for example, to determine a level of user engagement with the learning content, which can be mined or analyzed to determine which content requires modification, for example. The actions could further be analyzed to determine how much time users are spending reviewing particular elements of learning content or performing assessments, all of which could be utilized to refine and improve work assignments provided to users via a particular learning resource 304. And, additionally, the user events (particularly those in the form of assessment response actions) could be analyzed to identify problematic assessment content being generated by particular learning resources.

Rather than each learning resource 304 being required to implement their own analytics engines to process user events occurring within their platforms, the present system provides a centralized event processor 306 configured to parse and evaluate user events received from a number of different learning resources 304 to generate analytic reports that are consumable by each learning resource 304 separately.

During operation, therefore, the various learning resources 304 in environment 300 are configured to transmit all received user events to event processor 306. Specifically, the user events are transmitted to event queue intake 308, which is a data stream configured to transmit received event through event processor 306 for analysis. To provide a backup of user events passing through event processor 306, event queue intake 308 is configured to store duplicates of all received user events in event storage database 307.

Event processor 306 may be implemented as any suitable computer system (including single processor, multiprocessor, or distributed computing systems) for implementing software applications for processing and analyzing user event data from each of learning resources 304. Specifically, event processor 306 can include a number of different analytics modules 310a-310d for processing and analyzing received user event details. Different analytics modules 310 may be configured to determine a level of user engagement with particular types of content based on received user events, provide an analysis of how often users log into a particular learning resource 304 based on received user events, evaluate learning growth in particular students across a single learning resource 304 or multiple learning resources 304 based on received user events, and the like.

In the present embodiment, analytics module 310a is configured to analyze user events in different learning resources 304 to identify assessment content that is challenging or difficult for users.

To enable the operation of the various analytics modules 310, event processor 306 is configured to route all user events received via queue intake 308 to sorting entity 312.

Sorting entity 312 is a software module that stores a look-up table that identifies, for each analytics module 310 implemented by event processor 306, which user event types the analytics module 310 requires to operate. For example, an analytics module that determines how long user stay logged in to particular learning resources 304 may require access to all user events received from queue intake 308 that involve user logon or user logoff actions (in addition to others).

In the specific case of challenging content analytics module 310a, sorting entity 312 is configured to pass all user events involving responses to assessments received from queue intake 308 to challenging content analytics module 310a. User events involving assessment or assessment item responses (i.e., the user events that should be processed for challenging content) may be identified and distinguished from other user events (e.g., page scrolls or login/logout activity) can be identified by analyzing the user events for specific headers or encoding information, or for looking for user events containing certain data entries indicating that the user event is associated with an assessment response. For example, user events encoded to make certain predetermined schemas associated with assessment items responses may be identified by the sorting entity 312 to transmit those user events to challenging content analytics module 310a

To sort each received user event, sorting entity 312 is configured to inspect the data encoded within each user event to identify a user event type. Based upon the type, sorting entity 312 routes the user event to the one or more modules 310 that are configured to process and analyze user events of that type.

To illustrate, in an embodiment the structure of a user event associated with the complete of an assessment response may include a data packet encoded to store data values according to the information depicted in Table 1, below.

TABLE I

| Name | Value |
|---|---|
| Action Type | <assessment> |
| Item_id | {identifies the assessment item that |
| | generated this action} |
| Assessment_id | {Identifies the high-level assessment (e.g., |
| | quiz or test) to which the item identified |
| | by Item_id belongs} |
| Assessment_version | {Identifies the version of the assessment to |
| | which the item identified by Item_id |
| | belongs} |
| Assessment_type | {Identifies the type of the assessment to |
| | which the item identified by Item_id |
| | belongs} |
| Class_id | {identifies the class or course to which |
| | this assessment item belongs} |
| Attempt_number | {Identifies the number attempts |
| | performed by the user on the assessment |
| | to which the item identified by Item_id |
| | belongs} |
| Assessment_item_staticalgorithmictype | {Identifies whether the assessment item |
| | identified by Item_id is a static |
| | assessment item or generated |
| | algorithmically} |
| Assessment_item_learning_aids | {Identifies learning aids (and the duration |
| | for which the learning aids were viewed) |
| | that were available to user when |
| | generating the user event} |
| Assessment_item_work_type | {String value to identify the type of work |
| | undertaken to generate the user event- |
| | aids in categorization of the event} |
| Assessment_item_duration | {The duration of time required by the user |
| | in responding to the assessment item to |
| | generate the user event} |
| Correct_on_first_try | {Identifies whether or not the student |
| | answered the question correctly on the |
| | first try} |
| User_id | {identifies the user that generated this |
| | user event} |
| Date-Time | {The data and time at which this user |
| | event was generated} |
| Answer_id | {identifies the answer that was selected or |
| | entered by the user} |
| Correct-Status | {Boolean value identifying whether the |
| | answer was correct} |
| Role-ID | {An identification of the user's role-e.g., |
| | student, student athlete, teacher, research |
| | assistant, etc.} |
| Organization-ID | {An identification of the organization to |
| | which the user belongs, e.g., a particular |
| | school, company, or non-profit |
| | organization} |
| Assessment_item_response_code | {A string that identifies attributes of the |
| | user's response to the assessment item, |
| | including “Correct”, “PartlyCorrect”, |
| | “Incorrect”, “Unanswered”} |
| Assessment_item_response score | {Identifies the score achieved by the user |
| | for this assessment item} |
| Assessment_item_response score_adj | {Identifies the score achieved by the user |
| | for this assessment item as adjusted by a |
| | third party entity (e.g., human score or |
| | third party scoring system)} |
| Assessment_item_part_response score | {Identifies the score achieved by the user |
| | for a sub-part item in this assessment item- |
| | may be multiple of these values defined |
| | in the user event for assessment items |
| | including multiple sub parts) |
| Assessment_item_part_response score_adj | Identifies the score achieved by the user |
| | for a sub-part item as adjusted by a third |
| | party entity (e.g., human score or third |
| | party scoring system in this assessment |
| | item-may be multiple of these values |
| | defined in the user event for assessment |
| | items including multiple sub parts |
| Assessment_item_response pass_fail | {Identifies the pass/fail score achieved by |
| | the user for this assessment item} |
| Assessment_item_scoring_model | {Identifies an array of Scoring Models |
| | that were applied as part of scoring the |
| | student's response to the Item (multiple |
| | Scoring Models may be applied |
| | simultaneously with one of the models |
| | being the ‘Controlling’ model and the |
| | others being used for experimental or |
| | comparison purposes (e.g., A:B testing)).} |
| Resource-ID | {identifies the learning resource that |
| | generated the user event} |

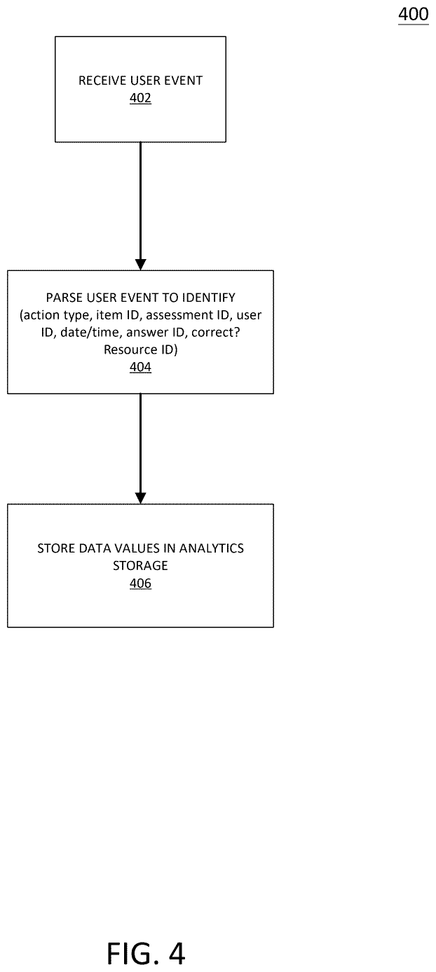

Upon receipt of a user event associated with a response to an assessment item from sorting entity 312, challenging content analytics module 310a is configured to parse the data identified in Table 1, above, and store the parsed data in a data record in an analytics storage database 314. The process of receiving, processing, and storing data encoded within an user event is further described and illustrated in FIG. 4 and corresponding written description. Each time challenging content module 310a receives user events from sorting entity 312, challenging content module 310a parses the data out of the received user event and stores that data in analytics storage database 314. This data is then used to generate reports of challenging content in response to requests received from the various learning resources 304.

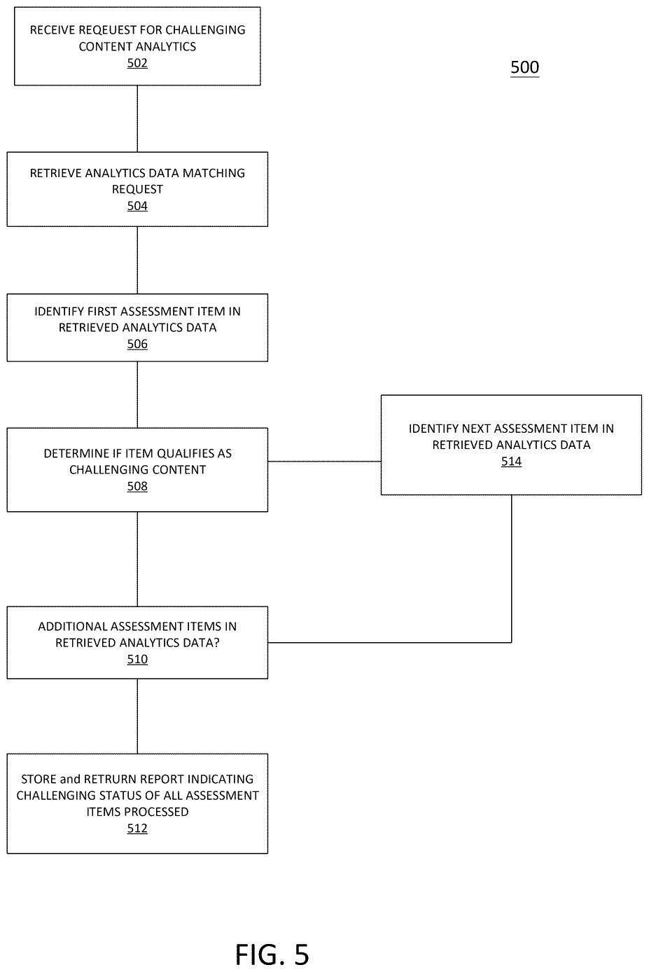

Specifically, event processor 306 includes an analytics report engine 316. Upon receipt of a request 318 for a challenging content report, event processor 306 is configured to parse the request to identify the requirement for the report, access the analytics storage database 314 to retrieve the data necessary to generate the report, compile the report, and transmit the report to the requesting learning resource 304. In some embodiments, a duplicate of the report may be stored in report stage database 351 enabling future comparisons with historically-generated report or comparisons of new approaches for identifying challenging content with historical approaches. Detail of this process is illustrated in FIG. 5 and the corresponding written description.

FIG. 4 is a flowchart depicting a method 400 for receiving and processing user event data received from a learning resource. Method 400 may be implemented by a software application running on an event processor (e.g., challenging content analytics module 310a implemented by event processor 306). In step 402, a user event is received. In an embodiment, the user event may be received from a sorting entity (e.g., sorting entity 312) via a queue intake (e.g., queue intake 308) configured to receive user event via a data stream from a plurality of learning resources.

After receipt of the user event, in step 404 the user event is parsed to identify the data values corresponding to those defined in Table 1, above. Specifically, the user event is parsed to identify all data values identified in Table 1, above, including at least an Item_id, an Assessment_id, a Class_id, a User_id, a Date-Time, an Answer_id, a Correct-Status, and a Resource-ID associated with the user event.

Once parsed, the values identified in the user event (including all items defined in Table 1, above, and not limited to Item_id, the Assessment_id, the Class_id, the User_id, the Date-Time, the Answer_id, the Correct-Status, and the Resource-ID) are stored in an analytics data database (e.g., analytics storage 314).

FIG. 5 is a flowchart depicting a method 500 for processing a request to generate a report of challenging content received from a particular learning resource. The method may be performed by an event processor (e.g., event processor 306 of FIG. 3) or a number of software components implemented by the event processor (e.g., analytics report engine 316).

In step 502 a request to generate a challenging content report is received. The report may be received from a learning resource (e.g., one of learning resources 304) of FIG. 3. In typical embodiments, the request encodes an identification of a particular assessment item, or set of items, for which the report is to be generated. The request may also include additional data to further limit or define the scope of the challenging content report.

For example, a particular request may identify a specific assessment item (e.g., a quiz question) to be evaluated, a particular assessment (e.g., a quiz or test) that contains or is associated with a number of different assessment items for which challenging content is to be identified, a particular class (e.g., associated with a particular set of users) for which the identified assessment items are to be evaluated for challenging content, a particular date range over which the identified assessment items are to be evaluated for challenging content, and the like.

If a particular assessment item is utilized by a number of different learning resources across a number of different assessments occurring in different classes, the report may be generated across all instances of the assessment ID across different learning resources and platforms. In that case a challenging content evaluation or report may be generated based upon all uses of the assessment item regarding of which learning resource or platform the assessment appears in. In other cases, however, the request may constrain the report so as to only include an analysis of the assessment item for a particular class or group of students, for example.

Similarly, the request may constrain the results to be analyzed (and the ultimate report generated) to instances of responses to the assessment item or collection of items for users belonging to a particular organization (e.g., using the Organization-ID value from the stored user event data). This enables an analysis of challenging content for a group of employees belonging to the same company, for example, or students attending the same school or university. In some cases, a number of different organizations could be included in the request enabling challenging content to be analyzed, for example, for a group of universities.

In a similar manner, the request may constrain the results to be analyzed (and the ultimate report generated) to instances of responses to the assessment item or collection of items for users belonging to a particular type of user, such as research assistants, employees, students, student athletes, etc. (e.g., using the Role-ID value from the stored user event data). This enables an analysis of challenging content for a group of users belonging to the same class or type of user. In some cases, a number of different user types could be included in the request enabling challenging content to be analyzed, for example, for a group of student athletes.

In some cases, the request may constrain the results to a particular geographical region (e.g., results for users in a particular state or geographical region), or across an entire country or group of countries.

Given the constraints identified in the request received in step 502, in step 504 a repository of analytics data (e.g., analytics storage database 314) is accessed to retrieve data associated with user events associated with assessment items matching or in accordance with the constraints that were defined in the received request.

In some embodiments, this data is filtered so that only a first user event involving the specific assessment item is retrieved and later user events associated with the same assessment item are filtered from (or otherwise removed from or deleted from) the data retrieved in step 504. This may involve only retaining, for each user_id contained within the set of analytics data retrieved in step 504 only the earliest user event associated with each assessment item (as identified by the date/time stamp associated with each user event). Later (as determined by the date/time stamp values) second, third, or greater user events contained within the data set may be discarded. In this manner, the data retrieved in step 504 (and filtered to remove users' subsequent user interactions with assessment items) may only include “first attempt” values. As such, the analytic report generates in accordance with method 500 will not include an analysis of second guesses or corrected answers.

In step 506, a first assessment item in the data retrieved in step 504 is identified. If the request originally received in step 502 identified a single assessment item for the generation of a challenging content report, the data retrieved in step 504 may only include data for that single assessment item.

If, however, the request identified a plurality of assessment items, the data retrieved in step 504 may include data for a number of different assessment items. For example, if the original request only identified a particular assessment (e.g., a quiz or test) for which the challenging content report was to be generated, the data retrieved in step 504 may include data for all assessment items contained within the identified assessment. If that is the case, method 500 operates to analyze the data associated with each assessment item separately.

Accordingly, in step 506 a first assessment item in the retrieved data is identified. With the first assessment item identified, in step 508 the assessment item is evaluated to determine the assessment item qualifies as challenging content. Any suitable evaluation method may be utilized. In an embodiment, the data associated with the item can be evaluated to determine a percentage of first-time user events for the assessment item are associated with a correct response (as identified by the Correct-Status tag). If the percentage of first-time user events for the assessment item that are associated with a correct response falls below a threshold (e.g., a predefined threshold percentage of 70%) the assessment item may be tagged as challenging content.

Alternatively, for assessment items that receive a real score, the data associated with the item can be evaluated to determine a percentage of first-time user events for the assessment item having achieved a score (e.g., Assessment_item_response score or Assessment_item_response score_adj) that exceeds a predetermined score threshold (different score thresholds may be defined for different learning domains). If the percentage of first-time user events for the assessment item that have scores exceeding the predetermined score threshold falls below a threshold (e.g., a predefined threshold percentage of 70%) the assessment item may be tagged as challenging content.

For assessment items having multiple sub-parts, the analysis could further involve determining for each sub-part whether a percentage of first-time user events for each assessment item sub-part has achieved a score (e.g., Assessment_item_part_response score or Assessment_item_part_response score_adj) that exceeds a predetermined score threshold (different score thresholds may be defined for different learning domains). If the percentage of first-time user events for the assessment item that have sub-part scores exceeding the predetermined score threshold falls below a threshold (e.g., a predefined threshold percentage of 70%) the assessment item may be tagged as challenging content.

In other embodiments, the threshold may be determined based upon historical performance of users undertaking the assessment item. For example, if, historically, an assessment item is answered correctly 80% of the time, the assessment item may be designated as challenging if the first-time user events for the assessment item that are associated with a correct response falls below 15% below that historical average value (in this example, 65%), the assessment item may be designated as challenging. In this case, the historical average value may be determined based upon all responses to the assessment item for all time, or for responses over a designated time frame (e.g., the historical average for the last two years).

With the assessment item evaluated in step 508, in step 510 it is determined whether additional assessment items are in the data retrieved in step 504. If not, the method proceeds to step 512 where a report is stored (e.g., in report storage database 351) and generated that indicates whether the assessment item evaluated in step 508 is tagged as challenging content. The report can then be transmitted to the learning resource from the request of step 502 was received.

By storing reports in step 512, a number of reports could be generated to identify challenging content using different sets of constraints or evaluation algorithms. The reports stored in report storage database 351 can then be compared to one another to optimize report generation algorithms on a go-forward basis.

If, however, in step 510 it is determined that additional assessment items are included in the data retrieved in step 504, the method moves to step 514 where a next assessment item is selected and method step 508 is repeated for the next assessment item to determine whether that assessment item is tagged as challenging content.

After all assessment items contained within the data retrieved in step 502 have been processed and evaluated, the method proceeds to step 512 to generate a report identifying each assessment item evaluated and an indication of whether the assessment items are tagged as challenging content. The report, once generated, is transmitted to the learning resource that generating the request of step 502.

Upon receipt of the reports generated by method 500, the learning resources can use the reports to generate informative reports to help users of the learning resource to identify challenging content. This could involve, for example, providing a dashboard for a teacher or other administrative user (e.g., an operator) of the learning resource to identify assessment items contained within a particular lesson segment that are designated as challenging. This information could be useful for a teacher or administrative user to designate additional learning material for users to review to enhance learning on the content associated with the challenging assessment items.

In a similar manner, learning resources can use the reports generated by method 500 to provide useful information for users of the learning resource. If the user is a student, for example, a learning resource could use the report to provide helpful information helping the student to identify challenging content enabling the student to spend more time studying material related to that challenging content.

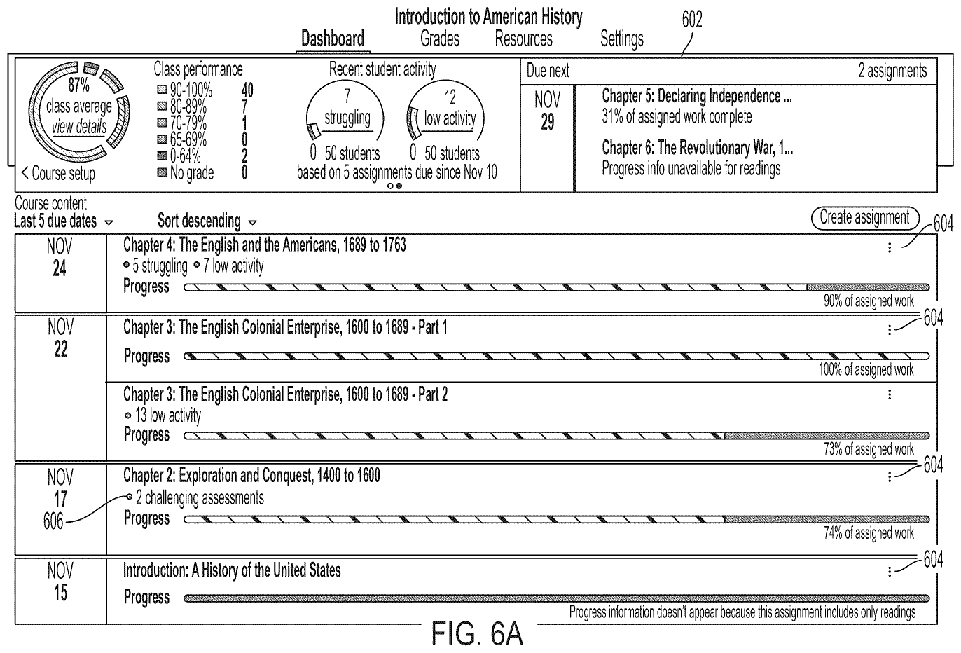

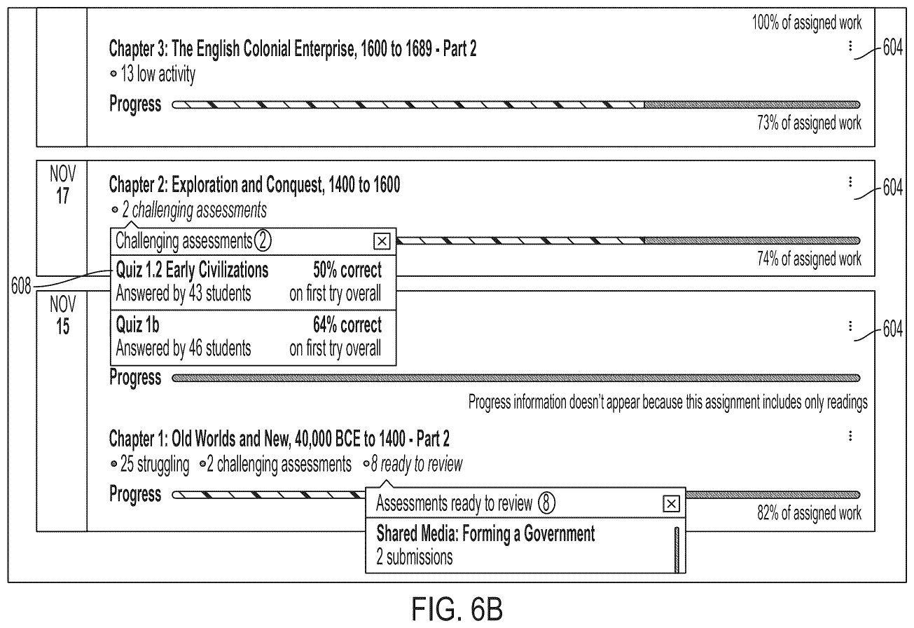

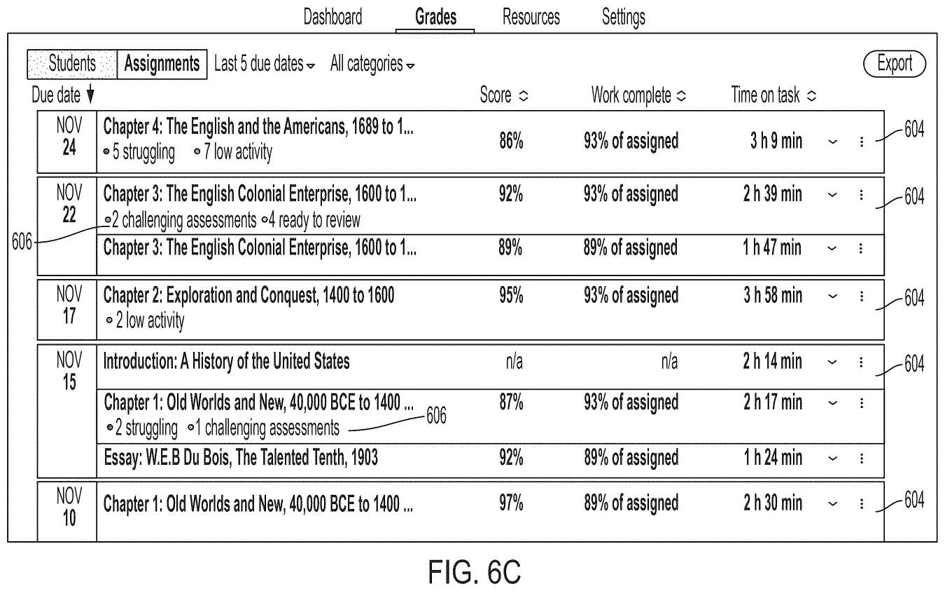

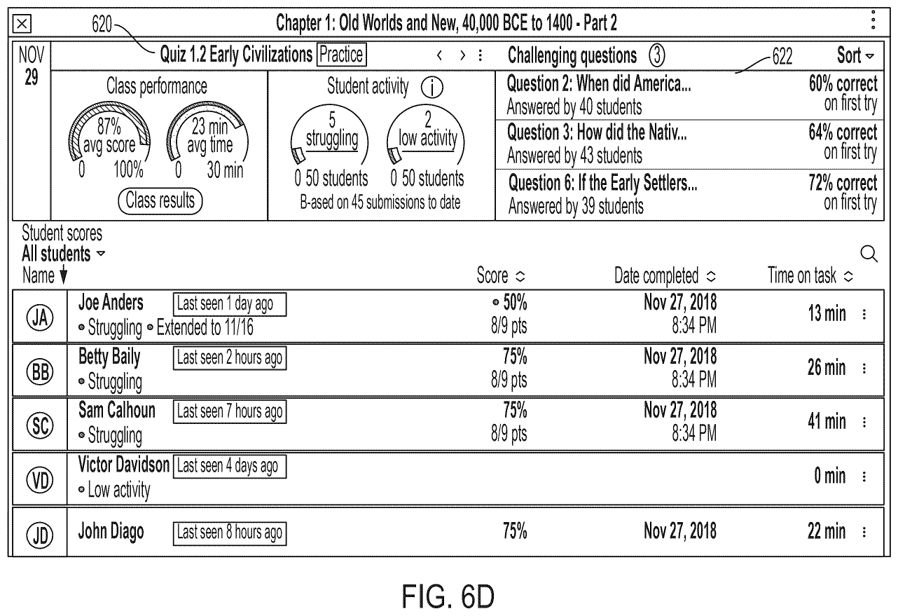

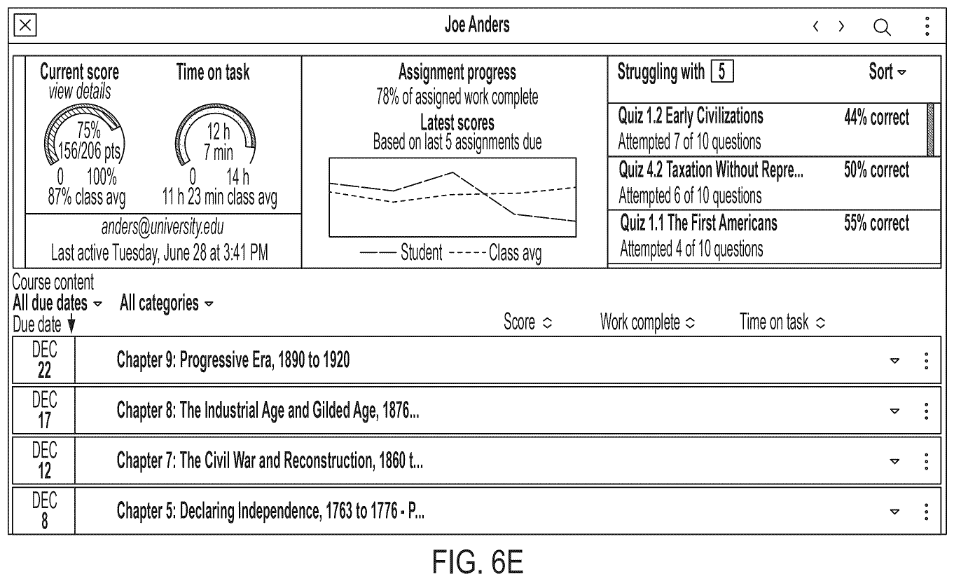

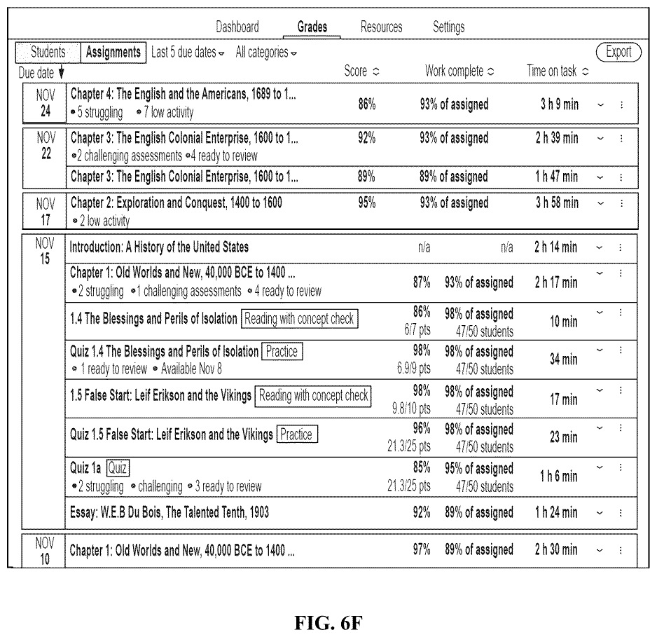

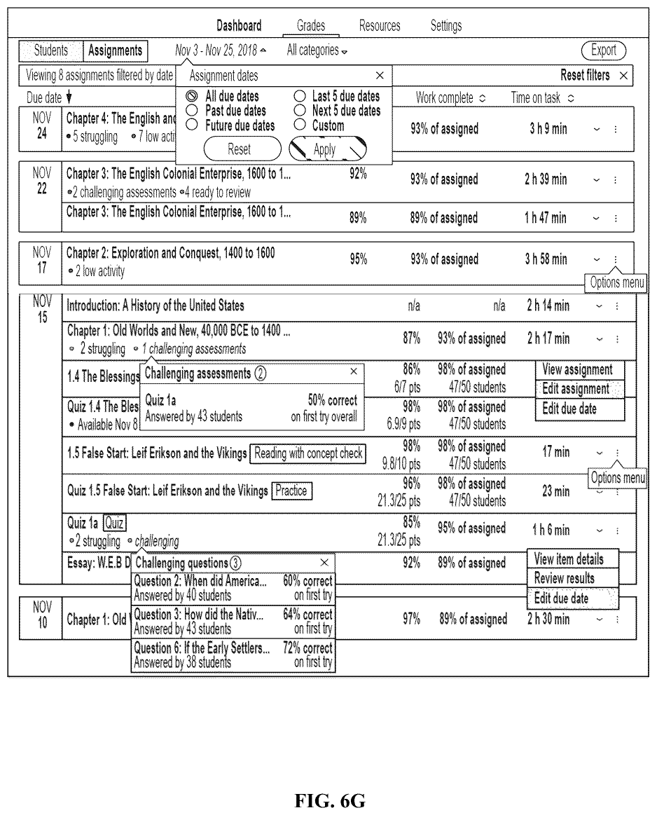

To illustrate, FIGS. 6A-6G are screenshots depicting example user interfaces generated and outputted to displays in accordance with a completed challenging content report generated in accordance with the method of FIG. 5.

FIGS. 6A and 6B depict reports that may be generated by a learning resource based upon indications of challenging assessment items included in a report received by an event processor (e.g., event processor 306 of FIG. 3). In FIG. 6A a dashboard is displayed. The dashboard includes a listing of assignments 604 that have been assigned to students. An indicator 606 is included in the listing of the November 17th assignment indicating that challenging assessment items and content has been identified with the November 17th assignment. This alert lets a teacher drill down to learn more about the content that was identified as challenging.

When selecting the November 17th assignment, the dashboard can provide a pop-up 608 as shown in FIG. 6B indicating which assessments contained within the assignment were challenging. The determination as to whether a particular assessment was challenging (as compared to a specific assessment item) can be generated by determining a percentage of individual assessment items contained within the assessment that were themselves determined to contain challenging content. If the percentage of individual assessment items contained within the assessment that were themselves determined to contain challenging content exceeds a threshold (e.g., 70%), the assessment itself may be determined to qualify as challenging content.

FIG. 6C shows a sample dashboard view listing a number of different assignments 604 in which a number of different assignments 604 contain challenging content as indicated by designations 606.

FIG. 6D depicts a dashboard that may be generated by a learning resource in which detail regarding a specific assessment 620 is displayed. Specifically, the dashboard incorporate an information window 622 in which a listing of assessment items contained with the specific assessment 620 that were considered challenging is displayed.

FIGS. 6E-6G depict dashboards that may be generated by a learning resource in which detail regarding challenging content for a specific user is displayed. Such reports can help inform the user of which content is, generally, challenging, which can be useful for the student in developing study plans and revision strategies.

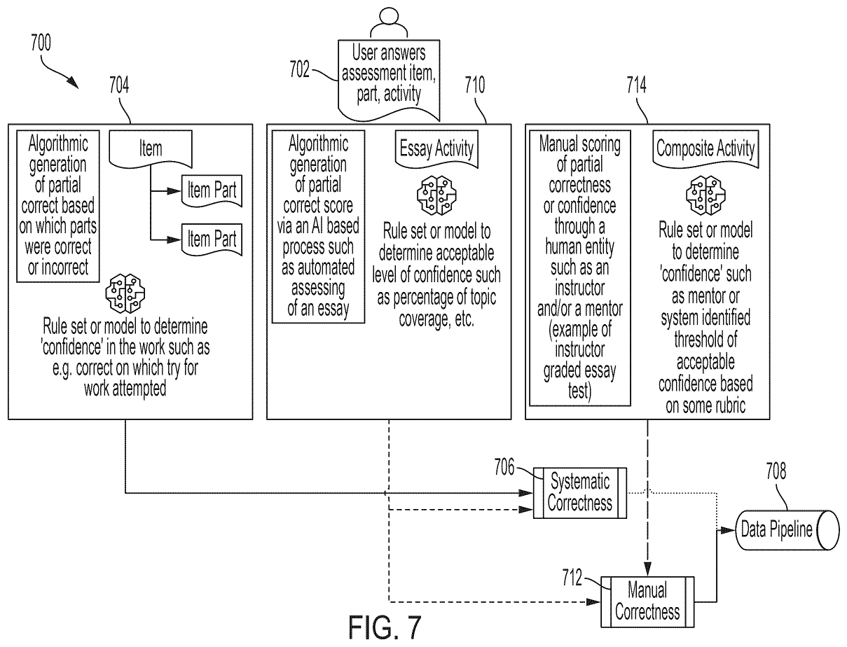

The present disclosure contemplates that a number of different approaches may be utilized to score assessment items (e.g., to generate the values “Assessment_item_response score”, “Assessment_item_response score_adj”, “Assessment_item_part_response score”, “Assessment_item_part_response score_adj”, and “Assessment_item_response pass_fail”) contained in the corresponding user event) once completed by a user. To illustrate, FIG. 7 is a block diagram illustrating a data flow 700 through the present system that include evaluations of assessment item responses. To initiate the evaluation a user 702 submits an answered to an assessment item. The user's response may fall into one of three categories.

In category 704, the response is a response type enabling automated analysis and scoring of the response. Such response types may include multiple choice answer responses, or responses in which typed strings (e.g., a typed number or word) can be evaluated for correctness automatically. Responses belonging to that category are transmitted to an automated or systematic correctness evaluator 706, which is configured to apply an automated evaluation algorithm to the user's response to generate a score. That score, once generated, can be incorporated into the user event generated based upon the user 702's response and transmitted to data pipeline 708 (e.g., event processor 306) for processing.

In category 710, the response is a response type enabling partially automated analysis and scoring of the response. Such response types may include essay responses that can be evaluated, to some degree, automatically for scoring, but may require further human scoring to ensure the user's response is properly evaluated. In that case, responses belonging to that category are transmitted to automated or systematic correctness evaluator 706, which is configured to apply an automated evaluation algorithm to the user's response to generate a score and manual scoring evaluator 712 to perform manual scoring. The manual scoring may involve the manual scorer modifying or adjusting the score generated by systematic correctness evaluator 706 to generate an adjusted score (e.g., “Assessment_item_response score_adj” or “Assessment_item_part_response score_adj”) that, once generated, can be incorporated into the user event generated based upon the user 702's response and transmitted to data pipeline 708 (e.g., event processor 306) for processing.

In category 714, the response is a response type requiring manual scoring. Such response types may include composite activities (e.g., comprehensive essay responses) that cannot be evaluated automatically. Responses belonging to that category are transmitted to a manual scoring evaluator 712 to perform manual scoring. Once generated, the score can be incorporated into the user event generated based upon the user 702's response and transmitted to data pipeline 708 (e.g., event processor 306) for processing.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

1-18. (canceled)

19. An electronic device comprising a software application running on a processor, the processor to:
receive, with a queue intake, user events from a plurality of resources, each of the plurality of resources implemented by a computer server;
route the user events from the queue intake to a sorting entity, each user event including data values;
parse, with a challenging content module, the data values in each user event, the challenging content module communicatively coupled to the sorting entity and an event storage database to store the parsed data values;
receive a request for challenging content from a first resource of the plurality of resources, and in response to receiving the request, the processor is to:
determine, from the request, a first assessment item and retrieve from the event storage database a first set of data values associated with the first assessment item;
determine a percentage of the first set of data values associated with a correct answer;
determine a threshold percentage, and identify the first assessment item as challenging content when the percentage is below the threshold percentage; and
generate outputs of the challenging content, each of the outputs uniquely generated to be usable by each of the plurality of resources.

20. The electronic device of claim 1, wherein a report engine generates the output and a report storage database stores the output, the report storage database being different from the event storage database.

21. The electronic device of claim 1, wherein the queue intake receives unstructured data from a first of the plurality of resources and receives structured data from a second of the plurality of resources.

22. The electronic device of claim 3, wherein the structured and unstructured data are simultaneously received in real-time.

23. The electronic device of claim 1, wherein output generated for the first resource is unstructured and output generated for a second resource of the plurality of resources is structured.

24. The electronic device of claim 1, wherein the data values comprise an item identification, an assessment identification, a class identification, a user identification, a date and time, an answer identification, a correct status, and a resource identification associated with the user event.

25. The electronic device of claim 1, wherein the processor includes an analytics report engine to:
retrieve data used to generate the outputs;
compile the outputs; and
transmit the outputs to the plurality of resources.

26. The electronic device of claim 1, wherein a duplicate of each output is stored in a report storage database, and subsequent outputs are compared to the outputs stored in the report storage database.

27. A method comprising:
receiving, with a queue intake, user events that include data values, the user events being received from two or more resources implemented by one or more computer servers;
routing the user events from the queue intake to a sorting entity;
parsing, with a challenging content module, the data values in each user event, storing, with an event storage database, parsed data values from the challenging content module;
receiving a request for challenging content from a first resource of the two or more resources, and in response to receiving the request:
determining from the request a first assessment item and retrieving, from the event storage database, a first set of data values associated with the first assessment item;
determining a percentage of the first set of data values associated with a correct answer and a threshold percentage,
identifying the first assessment item as challenging content when the percentage is below the threshold percentage; and
generating outputs of the challenging content, each of the outputs uniquely generated to be usable a corresponding resource of the two or more resources.

28. The method of claim 9, further comprising ranking each data value in a user event.

29. The method of claim 10, further comprising filtering data values based on specific content ranking requirements.

30. The method of claim 11, wherein the specific content ranking requirements include one or more of an aggregation level, individual learner's aggregation context, challenging items, and threshold setting.

31. The method of claim 11, further comprising returning only data values above a given rank score.

32. The method of claim 9, wherein receiving the user events comprises receiving user events in two or more different formats.

33. The method of claim 14, wherein receiving the user events comprises a first user event with structured data and a second user event with unstructured data.

34. A non-transitory tangible computer-readable medium comprising instructions when executed cause a processor of an electronic device to:
receive a first user event from a first resource implemented by a first computer server and a second user event from a second resource implemented by a second computer server, wherein the first and second user events are received in different formats;
parse the data values in each user event, and store the parsed data values in an event storage database;
receive a request for challenging content from the first resource, and in response to receiving the request, the processor is to:
retrieve a set of data values corresponding to the first resource;
determine a percentage of the first set of data values associated with a correct answer and determine a threshold percentage; and
identify the first assessment item as challenging content when the percentage is below the threshold percentage; and
generate, a first report of challenging content uniquely generated to be usable by the first resource and a second report of challenging content uniquely generated to be usable by the second resource.

35. The non-transitory tangible computer-readable medium of claim 16, wherein the first report is to generate a dashboard in the first resource, the dashboard comprising:
a list of assignments,
an indicator indicating one or more challenging assessment items are identified in an assignment,
a pop-up, responsive to selecting the assignment with one or more challenging assessment items, to identify content identified as challenging.

36. The non-transitory tangible computer-readable medium of claim 16, wherein a duplicate of each report is stored in a report storage database, and subsequent reports include a comparison between each subsequent report and the reports stored in the report storage database.

37. The non-transitory tangible computer-readable medium of claim 16, wherein the first report is to automatically generate a dashboard to identify challenging content in the first resource, and the second report is to automatically generate a dashboard to identify challenging content in the second resource.

38. The non-transitory tangible computer-readable medium of claim 16, wherein the data values are parsed to identify each of the user generating the user event, an assessment item, a specific resource from the plurality of resources, and an identification of a correct or incorrect answer.
